(19) United States
(12) Patent Application Publication
(10) Pub. No.: US 2023/0021817 A1
(43) Pub. Date: Jan. 26, 2023

(54) [1] COMMERCIALIZATION SELL SHEET SYSTEM FOR PATENTS AND PUBLISHED PATENT APPLICATIONS AND METHOD

(71) Applicant: Ray Arjomand, Sparks, NV (US)

(72) Inventor: Ray Arjomand, Sparks, NV (US)

(21) Appl. No.: 17/871,803

(22) Filed: Jul. 22, 2022

Related U.S. Application Data
(60) Provisional application No. 63/224,728, filed on Jul. 22, 2021.

(51) Int. Cl. G06F 16/955; G06F 16/9538

(52) U.S. Cl. CPC G06F 16/9558; G06F 16/9538; G06Q 50/184

(57) ABSTRACT

A system and method for electronically displaying an electronic sell sheet for an invention of a web patent document, the web patent document selected by a web patent search engine based on search parameters inputted by a third party accessing the web patent document search engine through the world wide web, the method comprising the following steps:

(A) storing the electronic sell sheet upon web accessed electronic database;

(B) hyperlinking the web patent document to the sell sheet;

(C) displaying web patent document, the display presenting a sell sheet area with one or more buttons;

(D) activating one button of the one or more buttons to open a window that displays the sell sheet;

wherein the sell sheet display shows visual media not shown in the display of the web patent document nor in the underlying published patent document for the web patent document.

### CROSS-REFERENCE TO OTHER APPLICATIONS

This application claims the benefit of U.S. Provisional Patent Application No. 63/224,728, filed on Jul. 22, 2021, and entitled “A Repository for Sell Sheets and Patents”, the entire contents of which are incorporated by reference.

### STATEMENT REGARDING FEDERALLY SPONSORED RESEARCH OR DEVELOPMENT

Not Applicable.

### REFERENCE TO A “MICROFICHE APPENDIX”

Not Applicable.

### STATEMENT REGARDING PRIOR DISCLOSURES BY THE INVENTOR OR A JOINT INVENTOR

Not Applicable.

### FIELD OF THE INVENTION

The present invention may relate to may apply to visual computer displays of patent and published patent applications obtained through an internet patent search engine that indexes patents and published patent applications. More specifically, the present invention may be related to the visual presentment of additional data and information not otherwise set forth in the respective patent or published patent application substantially relating to enhanced invention understanding, potential commercialization and sales for the respective invention as disclosed by a specific patent or published patent application.

### BACKGROUND

A web or web patent document may be obtained via the web (world-wide-web that may be composed of billions of electronically connected digital documents that are viewed in a web browser) over the internet (e.g., a global network of billions of servers, computers, and other electronic hardware) via a patent search engine, such as Google's patent search engine, that indexes patents and published patent applications. Web patent document, which may be a computer visually presented image of the documents as published by a patent office (like the United States Patent and Trademark Office), may be time consuming for lay person to read ad comprehend due to the web patent document's technical nature describing and claiming a respective invention (e.g., often written in a legal, formal or technical language and jargon.) Further, a patent office may restrict the type of visual media that may be submitted as part of a patent application due the nature of paper publication that an application or resulting patent may be subject to, corresponding national patent law, international patent treaty or the like.

Many laypeople (e.g., person generally that are not skilled or knowledgeable in how to draft and prosecute a patent application) may not know how to read a patent document, or in particular the patent document's claims language (e.g., the patent document's legal description of the boundaries of invention) to fully understand and know the breadth of the invention as set forth by a patent document. The drawings, if provided with the patent document, generally are black and white line drawings generally lacking in shading and other three-dimension art effects that may enhance a layperson's understanding of the respective invention. Furthermore, moving pictures and other visual media are generally not submitted to be part of the actual patent document publication in that a document format as substantially used by patent offices for patent application submission may not support those kinds of visual media. These internet and published patent documents may contain very little information that address practical issues on how to go about commercializing the invention, effecting sales on the invention, other further understanding on how to use invention. Many of these limitations generally originate within a patent office's rules and regulations for the original filing or submission of a patent application within that patent office and are reflected in the patent office's published patent and patent application documents. The web patent document is generally limited to that information presented by the original published patent document as issued by the respective patent office.

A substantially shown in FIG. 1, the visual presentation of the web patent document 12 may contain an invention identification information 18, abstract 14 (e.g., invention summary)) drawings 16, specification (not shown), claims 22 and the like. The specification may be seen as a factual explanation of how to make and use the respective invention of the patent document. The specification may set forth what the problem is the invention is trying to solve; a brief description or summary of the invention, a brief description of how the invention attempts to solve the problem, more detailed description of the invention (e.g., what are the invention's parts, how they work together, what they produce or make, etc.; a method or process of steps showing how the invention operates etc.).

The drawings 16 may display the parts, steps and other relevant information of the Specification. Elements of the drawings 16 may be numbered to reference the parts and steps as numbered in the Specification. Claims 22 are numbered sentences which set forth the legal description of the invention. The claims are what the patent examiner generally uses to determine whether or not the invention as put forth by the patent application is entitled to the 20-year monopoly granted by the respective government in return for the inventor(s) disclosing their invention to the public. If the invention is deemed worthy of the 20-year monopoly, the claims may then be used to determine which variations of the disclosed invention are protected by the said governmental monopoly.

Additionally, web patent documents 12, may have additional electronic functions that the original published paper patent document may not have. For the patent search engine (e.g., Google's patent search engine) may provide the web patent document with multiple original links (or hyperlinks) 20 to present additional visual displays of information relating to various subjects (e.g., prior art patents, other publications, cited references, other patents or published patent applications that may share a common inventor, etc.) These links 20 may, in keeping with the main body of the web patent documents, do not reference sales and commercialization information or further illustrate what the invention is in easily understood terms (e.g., lay terms), illustrations or other visual media. Comprehensively, the web patent document is generally limited to information presented by the original patent document as published and issued by the respective patent office.

What could be needed may be a means by which additional information (e.g., using means not usually found in an web patent document or published paper patent document such as color text, color images, color pictures, animations, video illustrations and the like) that could be linked to or directly shown web patent document display that could enhance a layperson's understanding of the associated invention as well as provide other information such as how the invention could be utilized.

### SUMMARY OF ONE EMBODIMENT OF THE INVENTION

Advantages of One or More Embodiments of the Present Invention

The various embodiments of the present invention may, but do not necessarily, achieve one or more of the following advantages:

the ability to change the functionality or characteristics of an web patent document (granted or pending patent application) by utilizing information and data otherwise not shown in the web patent document as published by a patent office, such as color pictures, color images, animation, audio and/or video clips to provide a lay person with a quicker and greater understanding of the associated invention and the invention's main benefits;

provide hyperlinked colorful sell sheet so formulated to allow a layperson to quickly grasp the essence of the invention of a web patent document and invention's main benefit(s) without having to read the multiple pages of the web patent document;

the ability to one click on the intent patent document to provide a layperson with shaded drawings, color images, still pictures, moving pictures, prototypes, animations, audio and videos can explain an invention better than black and white drawings that can enhance their understanding of the associated invention and how the invention could possibly be commercialized;

to provide a revenue source for company of the patent search engine that indexes patents, published patent applications or both, wherein the patent search engine company may collect a fee from the inventor for creating a hyper link on the web patent document display to the associated invention's enhanced information (e.g., sell sheet having invention explanations, invention purchase information, art media such as video clips or both describing or illustrating the invention, invention commercialization information and the like);

the ability to making patent searching easier and faster by allowing a layperson prior art searcher to click on the colorful sell sheet first, to quickly understand the essence of the invention and the said invention's main benefits without having to read the displayed web patent document;

to provide a repository of invention's sell sheets linked to web patent documents whose inventions are available for sale or licensing that are easily searchable by keywords in a patent search engine;

the ability to link a difficult to understand, technical, black and white web patent documents as located by a patent search engine to a colorful marketing and sales tool, videos clips and other informational means that help explain the associated inventions via a link on a respective web patent document; and

provide an electronic sell sheet that may be electronically-linked (e.g., hyper-linked) to web patent document, the electronic sell sheet may use lay terms to generally explain the web patent document's invention, the invention's difference from the prior art, the invention's benefits and how the invention may solve a problem that the prior art does not, further the electronic sell sheet may be visually enticing, and may further have colorful images and additional links to three dimensional virtual or real prototypes, and video clips demonstrating or explaining the invention.

These and other advantages may be realized by reference to the remaining portions of the specification, claims, and abstract.

### BRIEF DESCRIPTION OF ONE EMBODIMENT OF THE PRESENT INVENTION

One possible embodiment of the invention could comprise the establishing of a link or hyperlink on a display of an web patent document of a respective invention, the internet data document located on a first database that is accessed by a patent search engine that indexes patent and published patent applications to another database containing the data forming for an associated invention's sell sheet, the sell sheet as created by the invention's inventor to enhance a layperson's understanding of the web patent document, wherein the sell sheet could be sales brochure, flyer, video or other art media, a web page (such as product sale page on amazon online sales website, or a video clip or a video advertisement or informercial further explaining the invention in lay terms and the invention's benefits.

Another possible embodiment of the invention could comprise a computer visual display of an web patent document, the web patent documents being accessed from an web patent document database by a patent search engine that indexes patent and published patent applications, the display further allow a display such as sub window to present information from an another database to display commercialization and sales information on the associated invention, the information created by the invention's inventor and configured and directed to enhance a layperson's understanding of the associated invention and how commercialization and sales promotion of the association invention in the market place may occur, wherein the commercialization and sales information may contain art media forms usually not found with in a patent document as published by a patent office.

Yet another possible embodiment of the invention could comprise a method for electronically displaying an electronic sell sheet for an invention of a web patent document, the web patent document selected by a web patent search engine based on search parameters inputted by a third party accessing the web patent document search engine through the world wide web, the method comprising the following steps: storing the electronic sell sheet upon web accessed electronic database; hyperlinking the web patent document to the sell sheet; displaying web patent document, the display presenting a sell sheet area with one or more buttons; activating one button of the one or more buttons to open a window that displays the sell sheet; wherein the sell sheet display shows visual media not shown in the display of the web patent document nor in the underlying published patent document for the web patent document.

Still yet another possible embodiment of the invention could comprise a method for electronically displaying an electronic sell sheet for an invention of a web patent document, the web patent document selected by a web patent search engine based on search parameters inputted by a third party accessing the web patent document search engine through the world wide web, the method comprising the following steps: storing the electronic sell sheet upon the web patent document electronic database or other electronic database; hyperlinking the web patent document to the electronic sell sheet; displaying web patent document, the display of the web patent document further presenting a sell sheet area with one or more buttons; activating a button of the one or more buttons opening a first window that displays the sell sheet; wherein the sell sheet display shows information describing in lay terms what the invention is and how it operates.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a snapshot image of a partial page of the prior art, an existing web patent document (e.g., a published patent application) as obtained from a commercial patent database as accessed by a patent search engine.

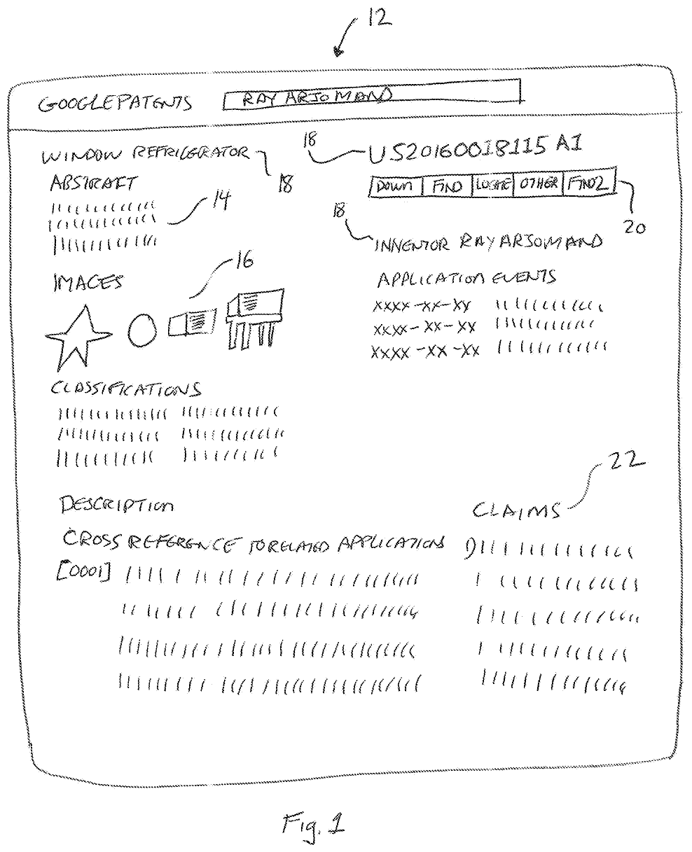

FIG. 2 is substantially a partial webpage representation of a web patent document showing one possible embodiment of the present invention when an activated a hyperlink opens a window display for the present invention's Sell Sheet in one possible embodiment of the present invention.

FIG. 3 is substantially a partial webpage representation of a web patent document showing one possible embodiment of the present invention having an activated hyperlink to the respective invention's video showing the respective invention's operation.

FIG. 4 is substantially a partial webpage representation of a web patent document showing one possible embodiment of the present invention having an activated hyperlink to the respective invention's additional sales and licensing information.

FIG. 5 is substantially a flowchart schematic showing one possible embodiment of a process or method of the present invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The present invention 10 could comprise an electronic sell sheet system 40 for web patent documents and method 100, wherein the system 20 could link a web patent document 12 and electronic sell sheet 52 (e.g., a sales flyer) generally a single-page document designed to provide product and service information to a potential customer.

The electronic sell sheet system 20 could operate on the world wide web (i.e., web) and the internet. The web could be one of the ways information is shared on the internet and may be composed of billions of connected digital documents that are viewed in a web browser or search engine, supported by the internet framework, a global network of billions of servers, computers, and other electronic hardware devices.

The electronic sell sheet system 20 may work in conjunction with a patent and published patent application database(s) as generally hosted by a patent search engine company, such as Google patents, wherein the patent search engine being connected to the world wide web operating on the internet, allows third parties to search the published patent and published patent database for desired web patent documents generally containing patent(s), published patent application(s) or both. It should be noted that patents are originally paper published documents. Not all patent applications are published, those patent applications that are published, are published in electronic format.

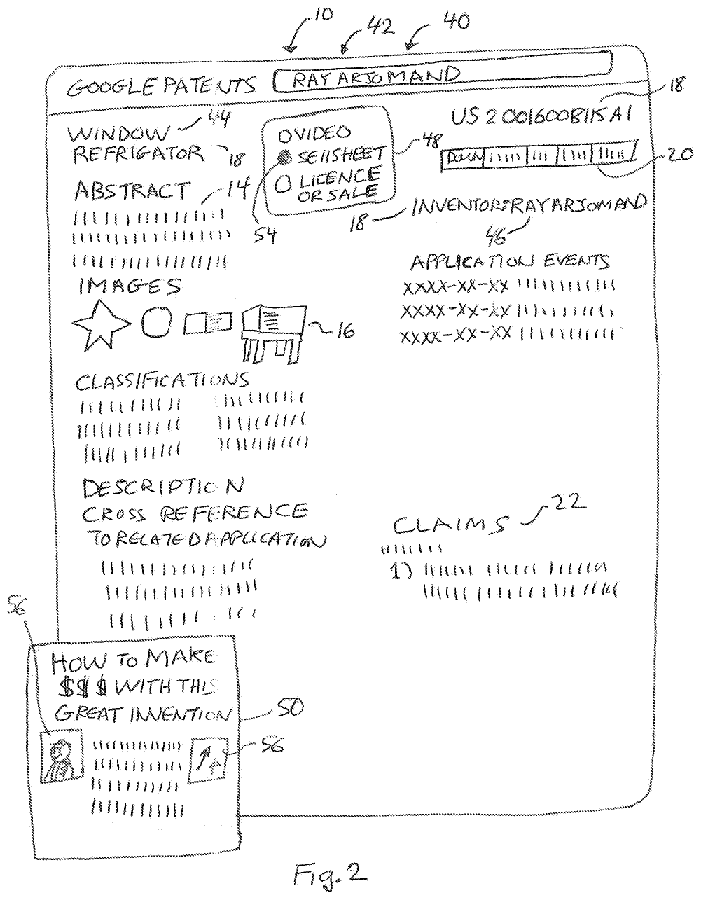

As substantially shown in FIG. 2, the system 40 may offered, by a patent search engine company, as a program to owners (e.g., inventors) of the published patent applications sand patents found within the respective company's web patent document database. For a set fee or fees, the company may establish a link or hyperlink with the computer visual presentation of the web patent document 42 as selected by the company's web patent search engine according to invention search parameters or the like as inputted to the company patent search engine by a third party. In response to these parameters, the web patent search engine, which indexes the said database, may retrieve and visually present (e.g., through a third party's smart device such as smart phone, tablet, computer or the like connected to the internet) from the web patent search engine a list of titles of web patent documents. When third party clicks upon one a particular title from the list, the patent search engine may visually present the respective web patent document 42. The visual presentation of the selected web patent document 42 (e.g., patent, published patent application, reissue document, or the like) may show the document information 18 (such as the name of the invention, issuance date, patent number), abstract 14 (e.g., summary of the invention), inventor names, (but generally not their contact information.) If the current owner of the invention of the respective web patent document agrees with the company (e.g., for annual fee paid to the company), the company may put near the top of the web patent document visual presentation 42 and area marked “SELL SHEET” 48 which denotes one or more link buttons (e.g., hyperlink) that can be activated by the searching third party clicking on same.

An activation of a button could open a new window or a sub-window 50 substantially overlaid upon a portion of the web patent document visual display 42. Upon sell sheet button 54 activation, the new window 50 could display the sell sheet 52 as created by the invention owner (e.g., inventor, assignee, applicant, etc.) and as hosted by the company or the invention owner (e.g., the electronic sell sheet 52 could be linked the respective web patent document 42.) The sell sheet 52 could use visual media 56 generally not found in the original published patent document due to limitations that may be imposed by the respective patent office rules and regulations and hence such visual media 56 is not normally found in the corresponding web patent documents. The sell sheet 52 could contain information that may assist the layperson (e.g., a potential purchaser of the invention) in understanding the invention of the selected web patent document. This could include additional information and the like generally not found in published patent documents, such as color drawings, instructions, 3D drawings with enhanced shading, prototype or images of actual product (invention), video illustrating the invention and the invention's benefits, information on how the associated invention could be sold and otherwise be commercialized and the like.

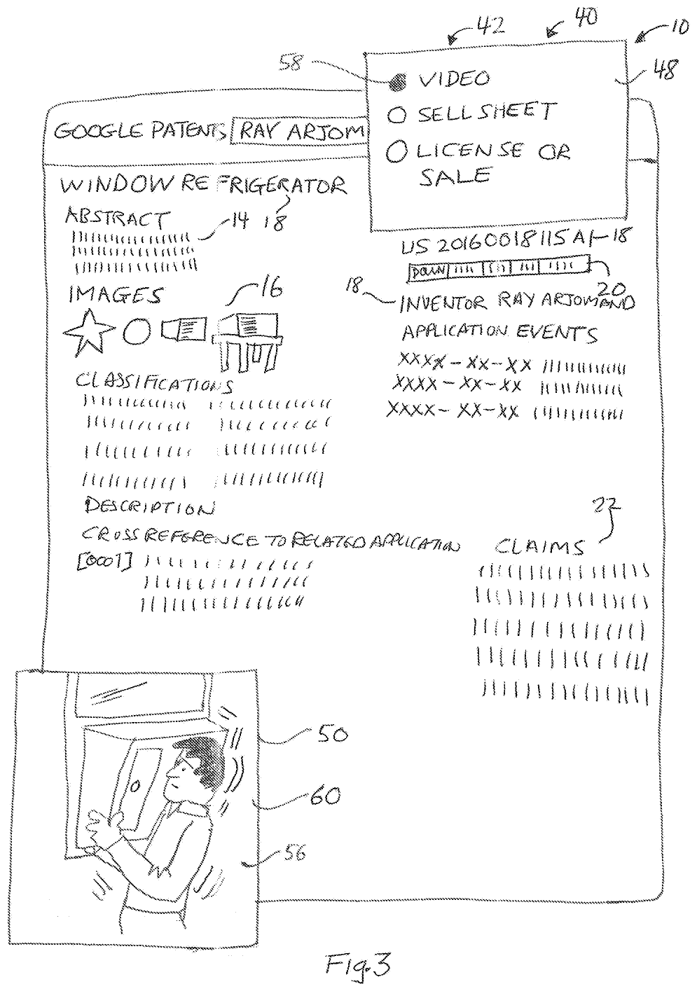

As substantially shown in FIG. 3, another button labeled “video” 58 as associated with the sell sheet area 48 could present visual displays showing other visual means such videos 60 (e.g., infomercial), amination, rotatable three-dimensional drawings and the like as provided by the invention owner to be linked (e.g., hyperlinked) to the desired web patent document 42. These visual display files could be hosted by either the company or by the invention owner.

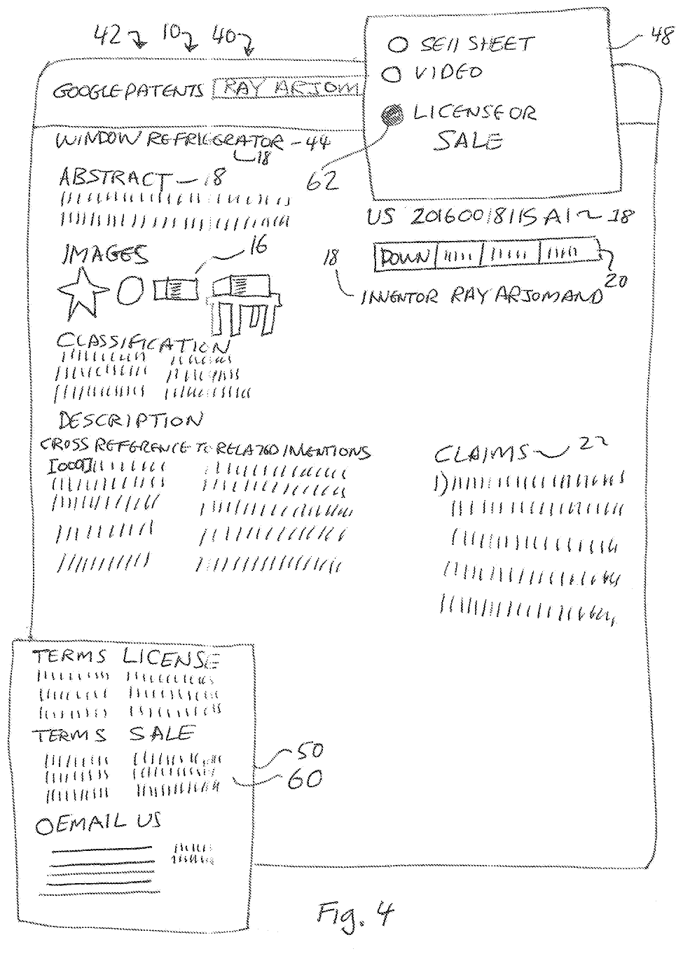

As substantially shown in FIG. 4, another button labeled “For license or sale” 62 and associated with the sell sheet area 48 could present visual displays showing the invention owner was offering to license or sell the underlying patent, published patent application or like of the web patent document. This display could show lease or sale information 64 such as possible fees and sales and licensing terms that the invention owner could be looking for as well as invention owner contact information (e.g., direct email contact capability as well).

In this manner, the invention 10 can be seen as being able to supply third parties (not shown) who are interested in a respective invention of a web patent document with easy-to-understand lay terms to better understand the under the invention and the invention's use(s) as displayed in a web patent document utilizing visual means not usually available with or restricted from the web patent document or the underlying published patent document. The invention may further provide license and sale terms if the invention owner or others wish to commercialize the respective invention.

### Method

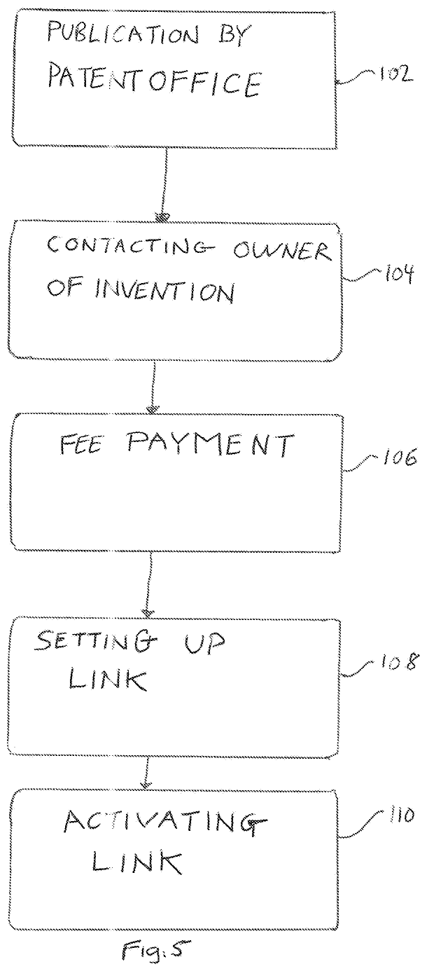

As substantially shown in FIG. 5, the method or process 100 for the invention 10 could start with step 102, publication by a patent office. In this step, after a patent application, namely a non-provisional patent application, is filed with a respective patent office (e.g., the United States Patent and Trademark Office) the said application may be published by the patent office as a published patent application if the submitted application meets certain criteria. Additionally, if the patent office decides to grant a patent upon a pending patent application, the resulting patent will be published. Once published, the patent office adds the said published patent documents to the patent office's online database of web patent documents. The patent office database is accessed by the patent-offices web patent document search engine that indexes the patent office's own web patent documents. At the time, the patent office, usually under an ongoing contract, may sell the electronic forms of the patent office's published patent documents to third-party, such as internet patent search engine companies like Google's patent search company. When the third party uploads the newly released published patent documents to the third party's web patent documents database, the new web patent documents can be made available through the third party's web patent document search engine (free to others as the public service; pay for service through subscription, or other access arrangements.) Such third parties may have in their respective databases web patent documents from several different patent offices.

Once the published patent documents are uploaded in the third party's web patent document database, the third party may have access to the basic contact information to the patent owner (e.g., inventor, assignor, etc.) inventor. Once this step is substantially concluded, the process 100 could proceed to step 104 contacting the patent or published patent application owner(s).

At step 104, contacting the patent or published patent application owner(s) the third party or web patent document database company may contact the owner of the invention for the selected web patent document assignee, licensee). In addition, the internet patent database company may ask additional questions from the inventor (or other owner of the invention from the selected web patent document), e.g., through filling out of form(s) sent to said person to find out more about the invention and inventor's needs. The form could ask such questions as: is the invention available for sale or licensing?; Does the inventor need to promote the invention to manufacturers or distributors in that particular industry or market niche?; Does the inventor need to secure financing?; Answering a few questions such as those can help the web patent document search engine company find out more about the invention, the market niche the invention is expecting to serve, the type of marketing help the inventor needs, etc. For example, if the inventor seeks financing, the web patent document search engine company can promote the invention to others such as angel investors, banks and other sources of capital. As this step is substantially accomplished, the process 100 can move onto the next step 106, fee payment,

At step 106, fee payment, if the web patent document search engine company wants to charge fee(s) for its services (e.g., linking the desired hosted web patent document to a sell sheet using visual media and information as supplied by the respective invention's owner; marketing services to promote the invention to that industry's manufacturers, business executives, distributors, investors, etc.) the patent search engine company could forward corresponding fee(s) information and fee payment capability information for those services to the said invention owner.

If the patent search engine company does not charge fee(s) or if the invention owner pays required fee(s) for the desired link service(s) then the process 100 could proceed to step 108, setting up the link. If the web patent document search engine company does charge fee(s) and the invention owner does not pay the required fees for desired services, then the process 100 can terminate.

At step 108, setting up the link, the invention owner (e.g., inventor, assignee, or the like) could send (via electronic format such as email attachment, e-file drop service, or the like) to the patent search engine company the invention's sell sheet or alternatively a web address or URL of the web page where the sell sheet is hosted on the internet—whichever means is acceptable to the patent search engine company. The sell sheet could further contain the patent application number or patent number of the invention of the desired web patent document that is the patent search engine company's web patent document database so the sell sheet can be electronically linked to the said web patent document. The sell sheet could contain information that assist the layperson (e.g., a potential purchaser of the invention) in understanding the invention. This could include information and the like generally not found in published patent documents, such as color drawings, instructions, 3D drawings with enhanced shading, information on how the associated invention could be sold and otherwise be commercialized and the like. Further, associated with the sell sheet could be other visual means such videos, amination, rotatable three-dimensional drawings and the like as provided by the invention owner to be linked to the desired web patent document.

Once the link is established between the sell sheet as hosted by the web patent document search engine company or as hosted the inventor owner or the like, and the web patent documents as hosted by the web patent document search engine company, third parties using the patent document search engine may pull up the respective web patent document to access the linked sell sheet.

If changes need to be made upon the sell sheet, and the sell sheet is hosted by the web patent document search engine company, the invention owner or like may contact the said company about making those sell sheet changes. If the sell sheet is hosted by the inventor owner, the inventor owner may make changes as necessary.

As this step is substantially completed, the process 100 could proceed to step 110, activating the link.

At step 110, activating the link, a third person may access the company's web patent document search engine and enter the search parameters for a desired invention or invention (or other search parameters such as inventor's name or the like. The search engine may return on a visual display a list of patent documents that may fall with the selected search parameters. If the third party selects a web patent document from the list, the search engine may visually display the selected web patent document. If the web patent document is linked to a sell sheet, the visual display for the selected web patent document may show an area near the top of the web patent document entitled “sell sheet.” A one or more hyperlink buttons may be located in this area. One such button may be entitled “sell sheet” and when clicked upon may open a new window or a sub-window with the web patent document showing in the background with this area. This window/sub-window may display the linked sell sheet displaying information in lay terms about the invention, how the invention works, how the invention could be sold, how the invention is an improvement over the prior art (e.g., earlier related inventions) and the like. The linked sell sheet could employ visual media generally not found in published patent documents, such color drawings with shading, rotatable three-dimensional drawings and the like. Another such button could be video and upon activation open another window or sub window to run a demonstration sales video that show how a person could use the invention and what results could be obtain by the invention in such an event. Yet another button in that area could be entitled “sales and licensing” and upon activation could open a window or sub-window having inventor owner contact information in detail as well as initial information for sale, licensing, or both as well as an email sending capability that the third party can use directly contact the invention owner.

In engaging the buttons under the Sell Sheet area of the web patent document as displayed by the system, the third party could easier gain a greater knowledge, as compared to the information just found in the published patent document, of what is the invention; how the invention works, how the invention may be deployed in the marketplace and other such issues.

### CONCLUSION

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. A method for electronically displaying an electronic sell sheet for an invention of a web patent document selected from the web patent document electronic database stored on the internet as accessed by a web patent search engine that indexes web patent documents of the said database, the web search engine selects the web patent document based on search parameters inputted by a third party accessing the web patent document search engine through the world wide web, comprising the following steps:
(A) storing the electronic sell sheet upon the web patent document electronic database or other electronic database;
(B) hyperlinking the web patent document to the electronic sell sheet;
(C) displaying web patent document, the display of the web patent document further presenting a sell sheet area with one or more buttons;
(D) activating a button of the one or more buttons opening a first window that displays the sell sheet;
wherein the sell sheet display shows one or more types of visual media not shown in the display of the web patent document nor in the underlying published patent document for the web patent document.

2. The method of claim 1 wherein the sell sheet display further sets forth in lay terms a description of the invention and how the invention works to facilitate the understanding of the concepts of the said invention by the third party.

3. The method of claim 1 wherein the first window is a sub-window that overlays a portion of the web patent document display.

4. The method of claim 1 further comprises a step of activating another button of the one or more buttons opening a second window that displays one or more videos that pertain to the invention.

5. The method of claim 1 further comprises a step of activating yet another button of the one or more buttons opening a third window that displays contact information for the owner of the invention of the web patent document, and other information of the leasing, sale or both of the said invention.

6. The method of claim 5 wherein the third window further displays a communication system for directly contacting the owner of the invention by email.

7. The method of claim 1 wherein the visual media is not allowed in United States non-provisional patent application under the terms of the United State Patent and Trademark Office Manual of Patent Examining Procedure.

8. The method of claim 6 wherein the visual media could be one visual media selection selected from a group of visual media consisting of color type, color background, color images, color pictures, audio presentation, movable three-dimensional drawings.

9. The method of claim 1 wherein the visual media is presented as a web page or video clip.

10. The method of claim 1 wherein the web patent document is a patent application published by a patent office.

11. A method for electronically displaying an electronic sell sheet for an invention of a web patent document selected from the web patent document electronic database stored on the internet as accessed by a web patent search engine that indexes web patent documents of the said database, the web search engine selects the web patent document based on search parameters inputted by a third party accessing the web patent document search engine through the world wide web, comprising the following steps:
(A) storing the electronic sell sheet upon the web patent document electronic database or other electronic database;
(B) hyperlinking the web patent document to the electronic sell sheet;
(C) displaying web patent document, the display of the web patent document further presenting a sell sheet area with one or more buttons;
(D) activating a button of the one or more buttons opening a first window that displays the sell sheet;
wherein the sell sheet display shows information describing in lay terms what the invention is and how it operates.

12. The method of claim 11 wherein the information further describes how to commercialize the invention and use the invention in the marketplace.

13. The method of claim 11 wherein the first window is a sub-window that overlays a portion of the web patent document display.

14. The method of claim 11 further comprises a step of activating another button of the one or more buttons opening a second window that displays one or more types of visual media not shown in the display of the web patent document nor in the underlying published patent document for the web patent document.

15. The method of claim 14 wherein the visual media is not allowed in United States non-provisional patent application under the terms of the United State Patent and Trademark Office Manual of Patent Examining Procedure.

16. The method of claim 14 wherein the visual media could be one visual media selection selected from a group of visual media consisting of color type, color background, color images, color pictures, audio presentation, movable three-dimensional drawings.

17. The method of claim 11 further comprises a step of activating yet another button of the one or more buttons opening a third window that displays contact information for the owner of the invention of the web patent document, and other information of the leasing, sale or both of the said invention.

18. The method of claim 17 wherein the third window further displays a communication system for directly contacting the owner of the invention by email.

19. The method of claim 11 wherein the web patent document is a patent granted by a patent office.

20. The method of claim 11 wherein information contained within the electronic sell sheet is obtained from the inventor of the invention as disclosed by the web patent document.

21. A method of presenting a hyperlink on a computer visual display, the said hyperlink connecting an electronic sell sheet with a web patent document comprising the following steps:
A. contacting an owner of an invention of web patent document by web patent document search engine company;
B. transferring electronic sell sheet from the owner of an invention of web patent document to the web patent document search engine company;
C. storing electronic sell sheet on a database that is indexed by the web patent document engine of the web patent document search engine company; and
D. creating a hyperlink between electronic sell sheet and a web patent document that is stored upon the said database.
